(19) United States
(12) Patent Application Publication
(10) Pub. No.: US 2006/0082271 A1
(43) Pub. Date: Apr. 20, 2006

(54) Light emitting device package and back light unit for liquid crystral display using the same

(76) Inventors: Seung Min Lee, Yongin-si (KR); Jun Ho Jang, Anyang-si (KR); Tae Hee Lee, Seoul (KR)

Correspondence Address: Song K. Jung;MCKENNA LONG & ALDRIDGE LLP, 1900 K Street, N.W., Washington, DC, 20006, US

(21) Appl. No.: 11/249,324

(22) Filed: Oct. 14, 2005

(30) Foreign Application Priority Data
Oct. 15, 2004 (KR) 2004-0082872

(51) Int. Cl. H05B 33/00; H01J 61/52; H01K 1/58; H01J 7/26

(52) U.S. Cl. 313/35; 313/512; 313/36

(57) ABSTRACT

A light emitting device package and a back light unit for liquid crystal display using the same wherein a fan is used to forcibly cool an LED package and a back light unit for LCD to increase the heat radiation efficiency and to prevent the degradation of the device.

### BACKGROUND OF THE INVENTION

1. Field of the Invention

The present invention relates to a light emitting device package and a back light unit for liquid crystal display using the same.

2. Description of the Prior Art

In general, the light emitting diode (LED) is a device for transforming electricity to light by utilizing a theory that, if a current is made to flow in a forward direction in a junction comprising two different semiconductors, electrons and holes are coupled at a junction region to generate a light beam. The said LED has an advantage in that it is resistant to shock, and has an almost eternal life time under a specific condition.

An LED exceeding an incandescent lamp has been currently developed. Furthermore, efforts have been recently waged to use an LED of high efficiency as a lighting apparatus. However, the said LED does not match the efficiency of fluorescent light and it does not seem to be that easy to outperform the efficiency of the fluorescent light within a short period of time.

Although the efficiency of LED does not match that of the fluorescent light, the LED contains no mercury causing an environmental pollution as in the fluorescent light such that studies on the LED are briskly progressed in terms of protection of environments.

Typically, the light source providing back-illumination (backlight unit. BLU) to liquid crystal display (LCD) devices is a Cold Cathode Fluorescent Light (CCFL). However, the CCFL contains mercury and is not a white light, exposing a limit in color expression of crystal display.

Meanwhile, although the LED is a monochromatic light source, and if three red, green and blue LEDs are combined, a variety of color temperatures can be expressed to make an excellent LED.

One of the drawbacks of LED is that efficiency drops and lifetime dramatically shortens if temperature of elements, particularly the temperature at a junction is increased to a prescribed level by heat generated by optical transformation process. Therefore, it should be imperative that LED be kept in an operating temperature under 90 degrees Celsius because its weakness to increase in temperature. However, heat radiation efficiency or density becomes decreased because the heat flow from high temperature to low temperature is in proportion to the temperature difference. For that reason, a particular heat radiation design is required for high efficiency lighting or application of LED for backlight unit.

Particularly, in case of a light source providing backlight unit to LCD using LED, the strong point of LCD that it is thin and light should be made the most of, such that it is necessary to design a heat radiation system to meet these conditions. In order to meet a luminance level required by an LCD of over 20 inches under the current element efficiency level, a heat radiation capacity of over 300 W/m² is required.

FIG. 1 is a schematic cross-sectional view of a backlight unit disposed at an LCD according to the prior art. Reference numeral 10 is an LCD. A dissipation sheet (20) is disposed at a rear surface of the LCD (10). At the rear surface of the dissipation sheet (10) there is positioned a substrate (30) and in front of the substrate (30) there is arrayed a plurality of LEDs (31). The substrate (31) is attached at the rear surface thereof with a rear surface sheet (40), and at the rear surface of the rear surface sheet (40) there is mounted a plurality of cooling fins (41).

The plurality of LEDs is a backlight source of the LCD (10) and the rear surface sheet (40) formed with the cooling fins (41) is cooling means for cooling the backlight source.

The LCD of a backlight unit using the LEDs according to the prior art can radiate approximately 8˜9 W/m²K even only with the thermal radiation and natural convection. However, the luminance required by a large display device is accompanied by a problem of heat generation four times that of the prior art, bring about a problem of the temperature of the rear surface sheet rising to almost 70 degrees Celsius if the ambient temperature is 30 degrees Celsius.

### SUMMARY OF THE INVENTION

The present invention is disclosed to solve the aforementioned problems and it is an object of the present invention to provide a light emitting device (LED) package and a back light unit for liquid crystal display (LCD) using the same adapted to forcibly cool the LED package and the back light unit of the LCD by using a fan and to increase a heat radiation efficiency and to prevent degradation of the devices.

In accordance with a first aspect of the present invention, an LED package comprises: a metal substrate; an insulation sheet formed at an upper surface of the metal substrate; a plurality of electrode lines formed on the insulation sheet; LEDs electrically bonded to an upper surface of the plurality of electrode lines and arrayed in rows and lines; a plurality of striped protruders fixed at one surface thereof to a lower surface of the metal substrate, each spaced a predetermined distance apart; a guide member fixed to the other surface of the protruders; and a fan case encased therein with a fan for sucking air through a suction inlet and disposed at a lateral surface of the metal substrate and the guide member for circulating the sucked air through spaces of the protruders.

In accordance with another aspect of the present invention, an LED package comprises: a body arrayed thereon with LEDs and formed thereunder with a plurality of striped protruders, each spaced a predetermined distance apart; and a suction fan infusing air through spaces of the plurality of protruders for cooling a lower section of the body and the plurality of protruders by sucking the air.

In accordance with still another aspect of the present invention, a back light unit for liquid crystal display (LCD) using LEDs comprising: a dissipation sheet disposed at a rear surface of LCD having a front surface and a rear surface; a substrate disposed at a rear surface of the dissipation sheet and arrayed at a front thereof with a plurality of LEDs; and a cooling apparatus cooling the substrate by discharging the air sucked by a fan to a rear surface of the substrate.

### BRIEF DESCRIPTION OF THE DRAWINGS

The above objects and other advantages of the present invention will become more apparent by describing in detail preferred embodiments with reference to the attached drawings in which:

FIG. 1 is a schematic cross-sectional view of a backlight unit disposed at an LCD according to the prior art;

FIG. 2 is a schematic perspective view of LED package according to the present invention;

FIG. 3 is a schematic perspective view of routes in which heat is generated from the LED package according to the present invention;

FIG. 4 is a schematic block diagram for illustrating of air being circulated in a LED package further disposed with additional FIG. 4 is a schematic block diagram for illustrating of air being circulated in a LED package further disposed with additional components according to the present invention;

FIGS. 5a and 5b are schematic cross-sectional views for describing formation of protruders on a metal substrate or a guide member according to the present invention;

FIG. 6 is a conceptual view of airflow where a fan case is further disposed for discharging air according to the present invention;

FIG. 7 is a schematic constitutional cross-sectional view of a back light unit for LCD according to the present invention;

FIGS. 8a and 8b are schematic constitutional cross-sectional views of layouts of a suction inlet formed at a cooling apparatus of a back light unit according to the present invention;

FIG. 9 is a schematic perspective view of a cooling apparatus mounted at a back light unit according to the present invention;

FIG. 10 illustrates a graph of measurement of a cooling efficiency of forcibly cooling a back light unit using a fan according to the present invention; and

FIG. 11 illustrates a graph of measurement of temperature changes of each part based on airflow according to the present invention.

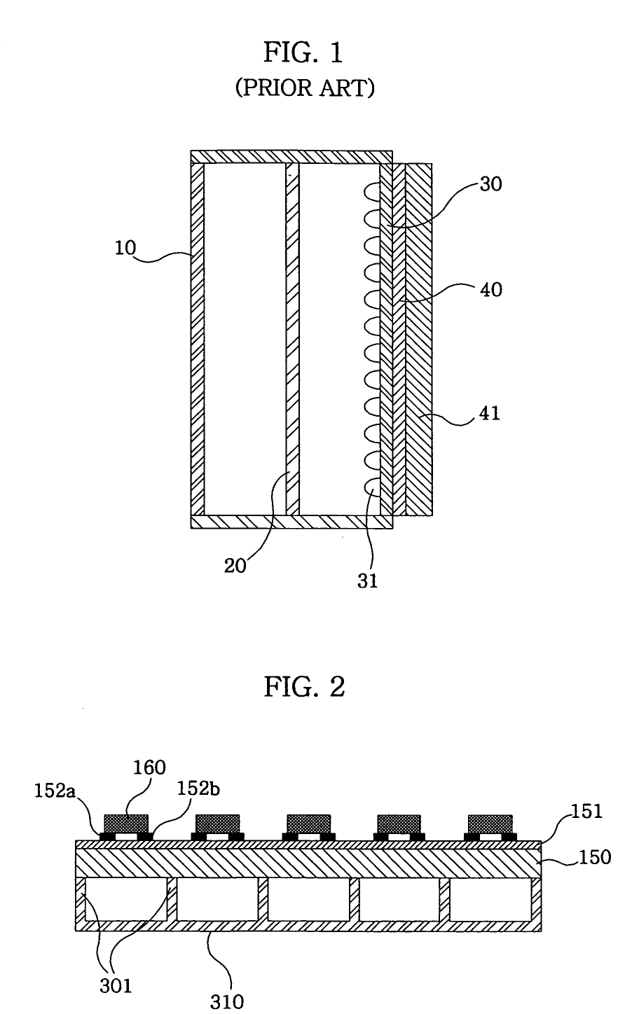

### DETAILED DESCRIPTION OF THE INVENTION

Preferred embodiments of the present invention will now be described in detail with reference to the accompanying drawings.

FIG. 2 is a schematic perspective view of LED package according to the present invention.

The LED package comprises: a metal substrate (150); an insulation sheet (151) formed at an upper surface of the metal substrate (150); a plurality of electrode lines (152a. 152b) formed on the insulation sheet (151); LEDs (160) electrically bonded to an upper surface of the plurality of electrode lines (152a. 152b) and arrayed in rows and lines; a plurality of striped protruders (301) fixed at one surface thereof to a lower surface of the metal substrate, each spaced a predetermined distance apart; and a guide member (310) fixed to the other surface of the protruders (301).

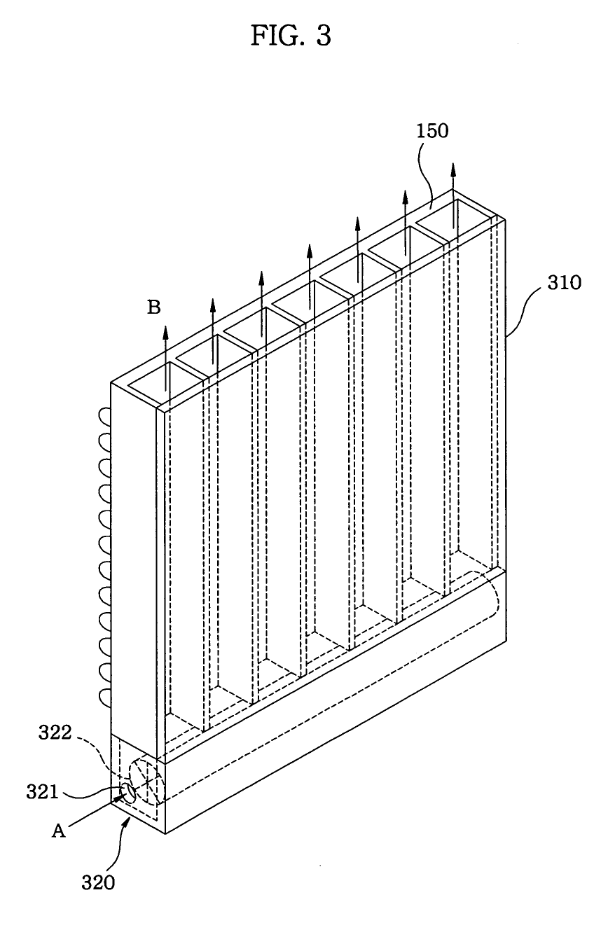

Referring to FIG. 3, the LED package is mounted therein with a fan (322) for sucking air through a suction inlet (321) and is further disposed with a fan case (320) encased therein with the fan (322) for sucking air through a suction inlet (321) and disposed at a lateral surface of the metal substrate (150) and the guide member (301) for circulating the sucked air through spaces of the protruders (301). Preferably, the fan (322) is a cross flow fan.

LED package thus constructed is such that the fan (322) is operated to suck the air through the suction inlet (321), and the sucked air is circulated among the spaces of the protruders (301) to forcibly cool the heat generated by the LEDs (160), thereby improving the cooling efficiency and preventing the degradation of the devices.

At this time, the heat generated by the LEDs (160) is transmitted to the metal substrate (150) and cooled by the air circulated along the bottom surface of the metal substrate (150).

Now, referring to FIG. 3, the air sucked in the ‘A’ direction through the suction inlet (321) of the fan case (320) serves to cool the metal substrate (150) and is discharged in the ‘B’ direction.

Furthermore, the heat eradiated from the metal substrate (150) is also transmitted to the protruders (301) which in turn are cooled by the contacted air to carry out the fin function.

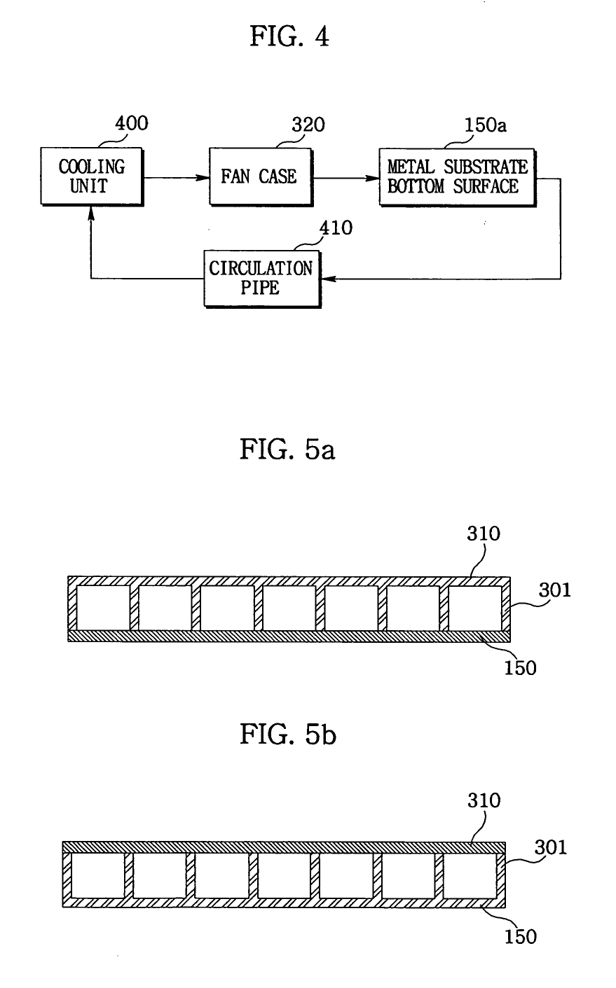

FIG. 4 is a schematic block diagram for illustrating of air being circulated in a LED package further disposed with additional components according to the present invention, where the air sucked by the fan of the fan case (320) is the air cooled by a cooling unit (400), and the cooled air flows along a bottom surface (150a) of the metal substrate to further enhance the radiating effect of the LED package.

In other words, preferably, the LED package of FIGS. 2 and 3 is further disposed with the cooling unit (400) for cooling the air and supplying the cooled air to the suction inlet of the fan case (320). Preferably, a circulation pipe (410) is further mounted for supplying to the cooling unit (400) the air which has flowed along the bottom surface (150a) of the metal substrate and then is discharged. Of course, the cooling unit (400) and the suction inlet of the fan case (320) are connected via a pipe such that the cooled air of the cooling unit (400) is introduced into the suction inlet of the fan case via the pipe.

FIGS. 5a and 5b are schematic cross-sectional views for describing formation of protruders on a metal substrate or a guide member according to the present invention. The metal substrate (150) of FIG. 5a is etched to form the protruders (301), and the protruders (301) and the metal substrate (150) are integrally formed. The guide member (310) and the protruders (301) of FIG. 5b are integrally formed.

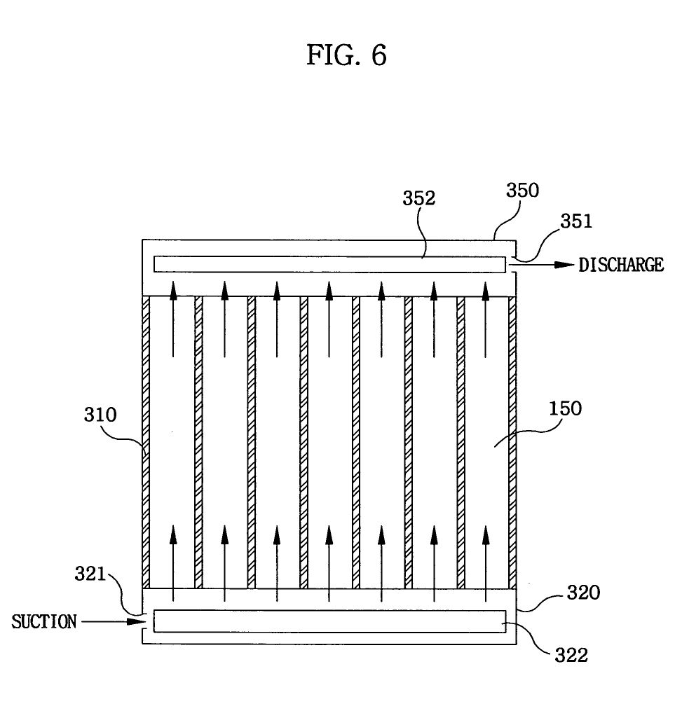

FIG. 6 is a conceptual view of airflow where a fan case is further disposed for discharging air according to the present invention, where the metal substrate (150) is mounted thereunder with the fan case (320) for air suction, and the metal substrate (150) is formed thereon with a fan case (450) for discharging the air.

In other words, the fan (322) of the fan case (320) for sucking the air serves to facilitate the suction of the air via the suction inlet (321), and the fan (352) of the fan case (350) functions to facilitate the discharge of the air via a discharge outlet (351). The air swiftly flows along the metal substrate (150) by the fan (322) of the fan case (350) for discharge of the air to cool the metal substrate (150) more efficiently.

Meanwhile, an LED package according to the present invention comprises: a body arrayed thereon with LEDs and formed thereunder with a plurality of striped protruders, each spaced a predetermined distance apart; and a suction fan infusing air through spaces of the plurality of protruders for cooling a lower section of the body and the plurality of protruders by sucking the air. Furthermore, the suction fan is formed at one lateral surface of the body, and is formed at the other lateral surface of the body with a discharge fan for sucking the air introduced through the plurality of protruders.

Preferably, the suction fan, the plurality of protruders and the discharge fan are hermetically sealed from the outside so that the air sucked from the suction fan is discharged via the plurality of protruders by the discharge fan and again sucked by the suction fan.

Between the suction fan and the discharge fan, there is further mounted a cooling unit for cooling the air discharged by the discharge fan and for supplying the cooled air to the suction fan.

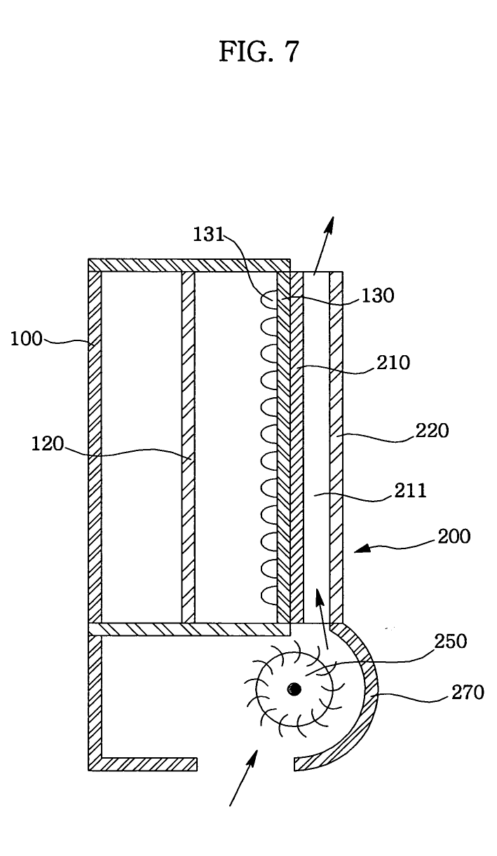

FIG. 7 is a schematic constitutional cross-sectional view of a back light unit for LCD according to the present invention.

The back light unit for liquid crystal display (LCD.100) using LEDs comprising: a dissipation sheet (120) disposed at a rear surface of the LCD (100) having a front surface and a rear surface; a substrate (130) disposed at a rear surface of the dissipation sheet (120) and arrayed at a front thereof with a plurality of LEDs (131); and a cooling apparatus (200) cooling the substrate (130) by discharging the air sucked by a fan (250) to a rear surface of the substrate (130).

The back light unit according to the present invention serves to forcibly cool the substrate (130) on which a plurality of LEDs (131) are arranged by sucking the air with the fan (250). The substrate (130) is made of metal and enhances the radiation efficiency of heat generated by the LEDs (131).

The cooling unit (200) comprises: a back surface sheet (210) attached at one side thereof to a rear surface of the substrate (130) where the plurality of LEDs (131) are frontally arranged and protruded at the rear surface thereof with a plurality of fins (211) each spaced at a predetermined distance apart; a guide member (220) attached to a distal end of the plurality of pins (211) and forming spaces among the pins; the fan (250) disposed underneath the substrate (130) for discharging the air sucked through the back surface sheet (210) and the guide member (220); and a fan case (270) fixed underneath the LCD (100) and the guide member (220) and having a suction inlet for sucking the air and mounted therein with the fan (250).

Preferably, the plurality of fins (211), the back surface sheet (210) and the guide member (220) are made of metal for enhancing the cooling efficiency.

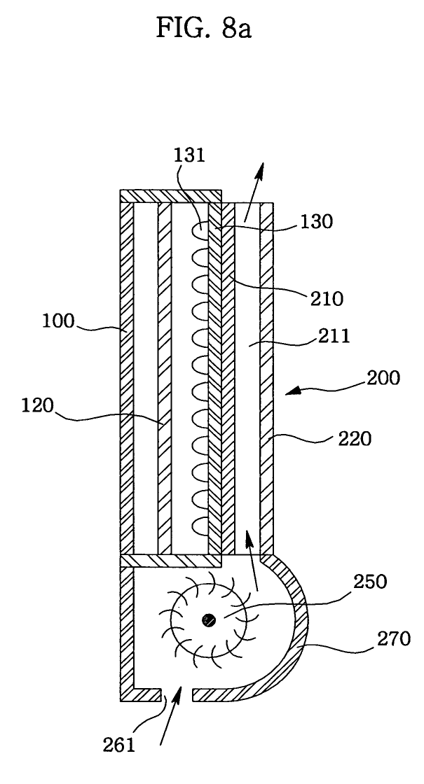

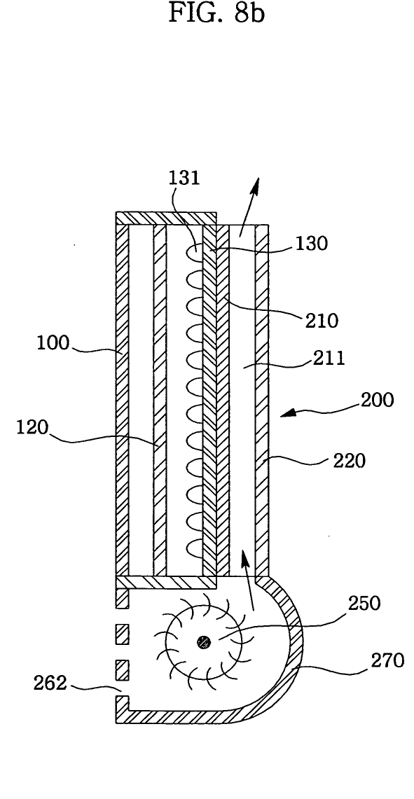

FIGS. 8a and 8b are schematic constitutional cross-sectional views of layouts of a suction inlet formed at a cooling apparatus of a back light unit according to the present invention.

Referring to FIG. 8a, a suction inlet (261) of the cooling unit (200) is formed underneath the fan case (270), or as illustrated in FIG. 8b, a suction inlet (262) is formed at a front surface of the fan case (270) which is in parallel with a front surface of the LED (100).

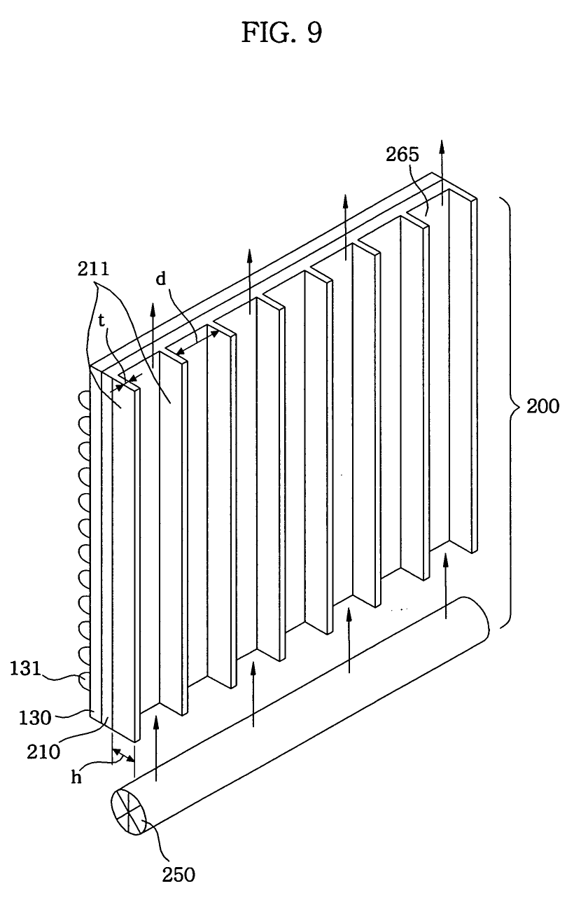

FIG. 9 is a schematic perspective view of a cooling apparatus mounted at a back light unit according to the present invention. The back surface sheet (210) disposed at the cooling apparatus (200) of the back light unit according to the present invention is attached to a rear surface of the substrate (130) on which the plurality of LEDs (131) are frontally arranged.

Furthermore, the distal end of the plurality of fins (211) formed at the back surface sheet (210) is attached with a guide member, and there are formed spaces among the pins.

If the fan (250) disposed underneath the substrate (130) charges the sucked air among the back surface sheet (210) and the guide member (220), the sucked air passes the spaces formed by the fins along the back surface sheet (210) and is discharged outside via a discharge outlet (265).

Preferably, the fan is a cross flow fan. In other words, the cross flow fan makes less noise than an axial flow fan but produces a larger amount of airflow such that the cross flow fan is adopted for the present invention.

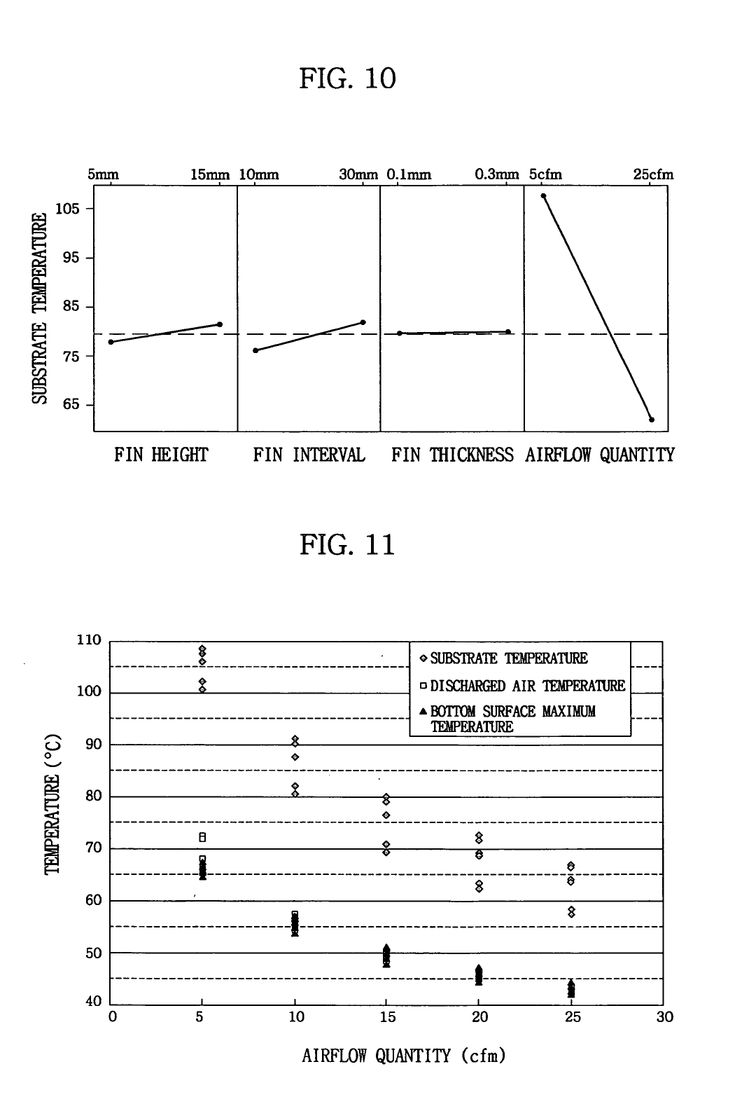

FIG. 10 illustrates a graph of measurement of a cooling efficiency of forcibly cooling a back light unit using a fan according to the present invention.

Referring back to FIG. 9, first of all, substrate temperature rises as fin height (h) and gap (d) are increased. Although increase and decrease of the fin thickness (T) do not affect the substrate temperature, the increase of the airflow at the fan can decrease the substrate temperature remarkably as in the present invention.

Subsequently, it can be noticed that a structure of the fan being used to forcibly cool the air increases the cooling efficiency according to the present invention as against the conventional art where the fin is used to cool the back light unit.

FIG. 11 illustrates a graph of measurement of temperature changes of each part based on airflow according to the present invention.

Referring to FIG. 11, the substrate temperature frontally arranged with the plurality of LEDs, the air temperature discharged by the discharge outlet and the maximum temperature of the back surface sheet decrease as the airflow increases.

In other words, it should be apparent that if the air is forcibly cooled using the fan, the cooling efficiency of the back light unit can be increased.

For reference, the heat radiation amount of the back light unit in the graph is 680 W/m², and the reason data value of each part is distributed to several pieces relative to each airflow is that measurements have been conducted by moving relevant parts.

As apparent from the foregoing, there is an advantage in the light emitting device (LED) package and a back light unit for liquid crystal display (LCD) using the same according to the present invention in that the fan is used to forcibly cool the LED package and the back light unit for LCD to increase the heat radiation efficiency and to prevent the degradation of the device.

While the present invention has been described in detail, it should be understood that various changes, substitutions and alterations can be made hereto without departing from the spirit and scope of the invention by persons skilled in the art.

What is claimed is:

1. An LED package comprising:
a metal substrate;
an insulation sheet formed at an upper surface of the metal substrate;
a plurality of electrode lines formed on the insulation sheet;
LEDs electrically bonded to an upper surface of the plurality of electrode lines and arrayed in rows and lines;
a plurality of striped protruders fixed at one surface thereof to a lower surface of the metal substrate, each spaced a predetermined distance apart;
a guide member fixed to the other surface of the protruders; and
a fan case encased therein with a fan for sucking air through a suction inlet and disposed at a lateral surface of the metal substrate and the guide member for circulating the sucked air through spaces of the protruders.

2. The LED package as defined in claim 1 further comprising a cooling unit for cooling air and for supplying the cooled air to the suction inlet of the fan case.

3. The LED package as defined in claim 1 further comprising a circulation pipe for supplying the air discharged from spaces among the plurality of protruders to the cooling unit.

4. The LED package as defined in claim 1, wherein the fan is a cross flow fan.

5. The LED package as defined in claim 1, wherein the metal substrate and the protruders are integrally formed.

6. The LED package as defined in claim 1, wherein the guide member and the protruders are integrally formed.

7. An LED package comprising:
a body arrayed thereon with LEDs and formed thereunder with a plurality of striped protruders, each spaced a predetermined distance apart; and
a suction fan infusing air through spaces of the plurality of protruders for cooling a lower section of the body and the plurality of protruders by sucking the air.

8. The LED package as defined in claim 7, wherein the suction fan is formed at a lateral surface of the body and a discharging fan is further mounted at the other lateral surface of the body for sucking the air introduced among the plurality of protruders and discharging the air.

9. The LED package as defined in claim 8, wherein the suction fan, the plurality of protruders and the discharge fan are hermetically sealed from the outside so that the air sucked from the suction fan is discharged via the plurality of protruders by the discharge fan and again sucked by the suction fan.

10. The LED package as defined in claim 9, wherein, between the suction fan and the discharge fan, there is further mounted a cooling unit for cooling the air discharged by the discharge fan and for supplying the cooled air to the suction fan.

11. The LED package as defined in claim 9, wherein the fan is a cross flow fan.

12. A back light unit for liquid crystal display (LCD) using LEDs comprising:
a dissipation sheet disposed at a rear surface of LCD having a front surface and a rear surface;
a substrate disposed at a rear surface of the dissipation sheet and arrayed at a front thereof with a plurality of LEDs; and
a cooling apparatus cooling the substrate by discharging the air sucked by a fan to a rear surface of the substrate.

13. The back light unit as defined in claim 12, wherein The cooling unit comprises:
a back surface sheet attached at one side thereof to a rear surface of the substrate where the plurality of LEDs are frontally arranged and protruded at the rear surface thereof with a plurality of fins each spaced at a predetermined distance apart;
a guide member attached to a distal end of the plurality of pins and forming spaces among the pins;
the fan disposed underneath the substrate for discharging the air sucked through the back surface sheet and the guide member; and
a fan case fixed underneath the LEDs and the guide member and having a suction inlet for sucking the air and mounted therein with the fan.

14. The back light unit as defined in claim 13, wherein the suction inlet a suction inlet of the cooling unit is formed underneath the fan case, or is formed at a front surface of the fan case which is in parallel with a front surface of the LED.

15. The back light unit as defined in claim 12, wherein the fan is a cross flow fan.

16. The back light unit as defined in claim 12, wherein the substrate is made of metal.

17. The back light unit as defined in claim 13, wherein the plurality of fins and the rear surface, and the guide member are made of metal.
